(19) United States
(12) Patent Application Publication
(10) Pub. No.: US 2012/0086180 A1
(43) Pub. Date: Apr. 12, 2012

(54) INVISIBLE DOLLY

(76) Inventor: Vegan Fakhoorian, Sedalia, KY (US)

(21) Appl. No.: 13/228,780

(22) Filed: Sep. 9, 2011

Related U.S. Application Data
(60) Provisional application No. 61/381,103, filed on Sep. 9, 2010.

(51) Int. Cl. B62B 5/00

(52) U.S. Cl. 280/79.11

(57) ABSTRACT

A dolly for transporting and moving baskets or other commercial and industrial loads. The dolly body or platform is rectangular in shape with a flat, smooth top. It may be attached, latched or fastened to the underside of the basket, tray or load being transported or moved, fitting within a space or pocket on the underside of the basket or tray. The two longitudinal sides are thicker than the center, providing strength and support, while the thinner center allows the weight of the dolly to be reduced. The dolly has no edges, rim, wall or protrusions around its perimeter.

This application claims benefit of and priority to U.S. Provisional Application No. 61/381,103, filed Sep. 9, 2010, by Vegan Fakhoorian, and is entitled to that filing date for priority. The specification, figures and complete disclosure of U.S. Provisional Application No. 61/381,103 are incorporated herein by specific reference for all purposes.

### FIELD OF INVENTION

This invention relates to a dolly and basket or tray for use in transporting and moving loads.

### BACKGROUND OF THE INVENTION

The use of dollies to support and move objects is well known in the prior art. Dollies are commonly used to transport or move boxes, goods, materials, files, furniture, and the like. In some instances, a tray or basket is placed on the dolly. In some cases, multiple trays or baskets are stacked on top of each other, supported by a single dolly. Examples of dollies are disclosed is U.S. Pat. Nos. 6,607,199 and 6,979,005, which are incorporated herein in their entireties by specific reference for all purposes.

However, prior art dollies contain a number of cavities, holes, cut-outs, or similar spaces for a variety of reasons, such as reducing weight or stacking. These cavities and spaces collect dirt and dust and attract insects, such as spiders, which can cause problems and contamination when transporting food or food-related items.

### SUMMARY OF INVENTION

In various embodiments, the present invention comprises a dolly for transporting and moving baskets or other commercial and industrial loads. In one exemplary embodiment the dolly body or platform is rectangular in shape with a flat, smooth top. It may be attached, latched or fastened to the underside of the basket, tray or load being transported or moved. The two longitudinal sides are thicker than the center, providing provide strength and support, while the thinner center allows the weight of the dolly to be reduced or lowered. The dolly body has no cavities or similar spaces.

In one embodiment, the dolly is made of derlin, although any suitable material such as other plastics, wood, metal, aluminum, steel magnesium, fiberglass, or composite may be used. The dolly may be black, white, or any other color or combination of colors.

In one embodiment, casters, which may be wheels, balls, or the like, are affixed to underside of the dolly in or near the four corners. Four holes may be placed in each corner to receive a bolt or screw for fastening the casters. Additional holes may be provided to permit the fastening of the dolly to a basket with bolts or screws.

The present invention possesses several advantages over dollies in the prior art. The design of the dolly renders it unable to be seen when in normal use (i.e., “invisible”). In this embodiment, the dolly has no edges, rim, wall or protrusions around its perimeter. The dolly fits within the space or pocket on the underside of a basket or tray. In one exemplary embodiment, the dolly is ¾″ inch thick at the sides, and ½″ inch thick in the center. The thick sides extend 4 inches into towards the center, with the dolly being 20 to 21 inches wide and 25 to 26 inches long. However, the dolly can be manufactured in different sizes to accommodate different sizes of baskets or loads.

The basket or tray sits closer to the floor than with conventional dollies, thereby allowing for more product to be hauled within a given space. It is lightweight for easy maneuverability. The casters do not interfere with loading and unloading of a truck. The dolly washes very easily, and has no cavities where dirt can collect or insects can hide and lay eggs. The latter is particularly important in food facilities to prevent food contamination.

### BRIEF DESCRIPTION OF THE DRAWINGS

FIG. 1 shows a top view of a dolly in accordance with an embodiment of the present invention.

FIG. 2 shows a front end cutaway view of the dolly of FIG. 1.

FIGS. 3-10 shows views of the dolly of FIG. 1 in use with a basket.

### DETAILED DESCRIPTION OF EXEMPLARY EMBODIMENTS

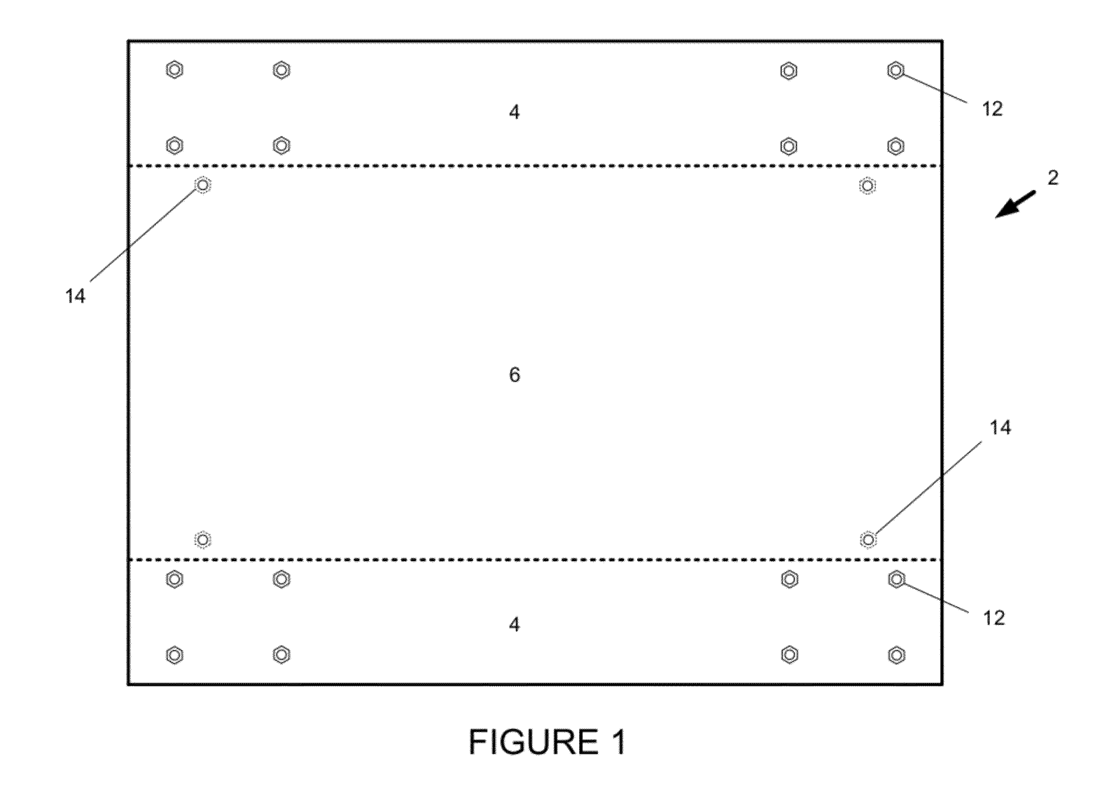

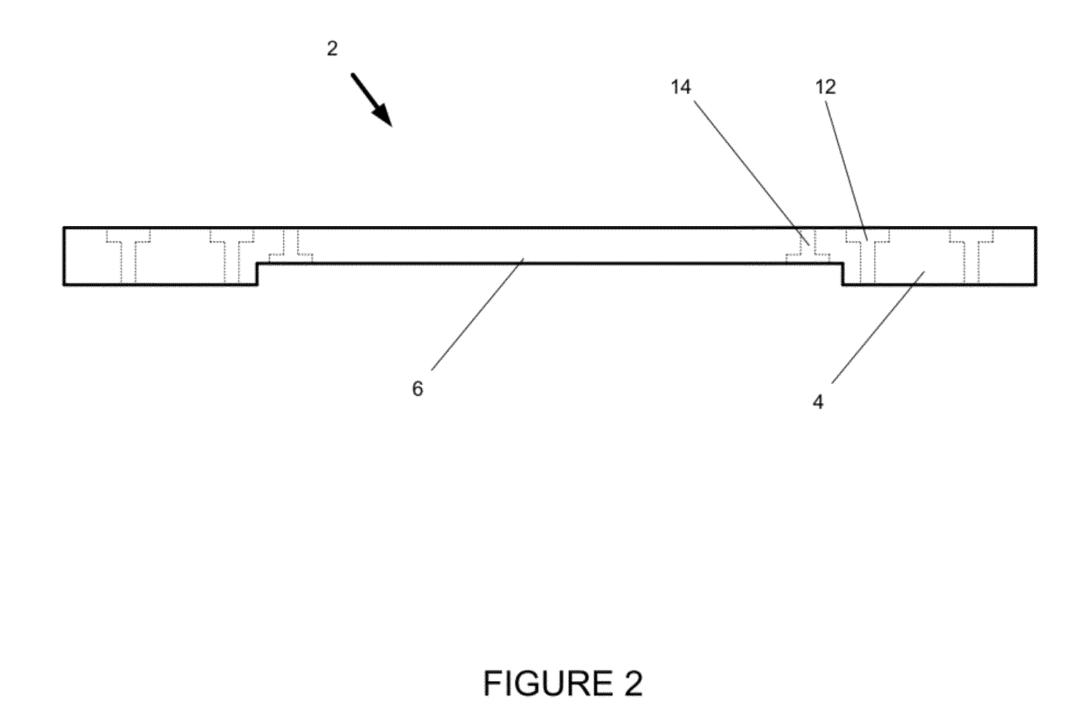

In various exemplary embodiments, the present invention comprises a dolly for transporting and moving baskets or other commercial and industrial loads. As shown in FIGS. 1 and 2, in one exemplary embodiment the dolly body or platform 2 is rectangular in shape. It may be attached, latched or fastened to the underside of the basket, tray or load 20 being transported or moved (see FIG. 10). The two longitudinal sides 4 are thicker than the center 6, as seen in FIG. 2. The thicker sides 4 provide strength and support, while the thinner center 6 allows the weight of the dolly to be lowered. As shown, the dolly has a flat top and bottom, with no cavities or similar spaces.

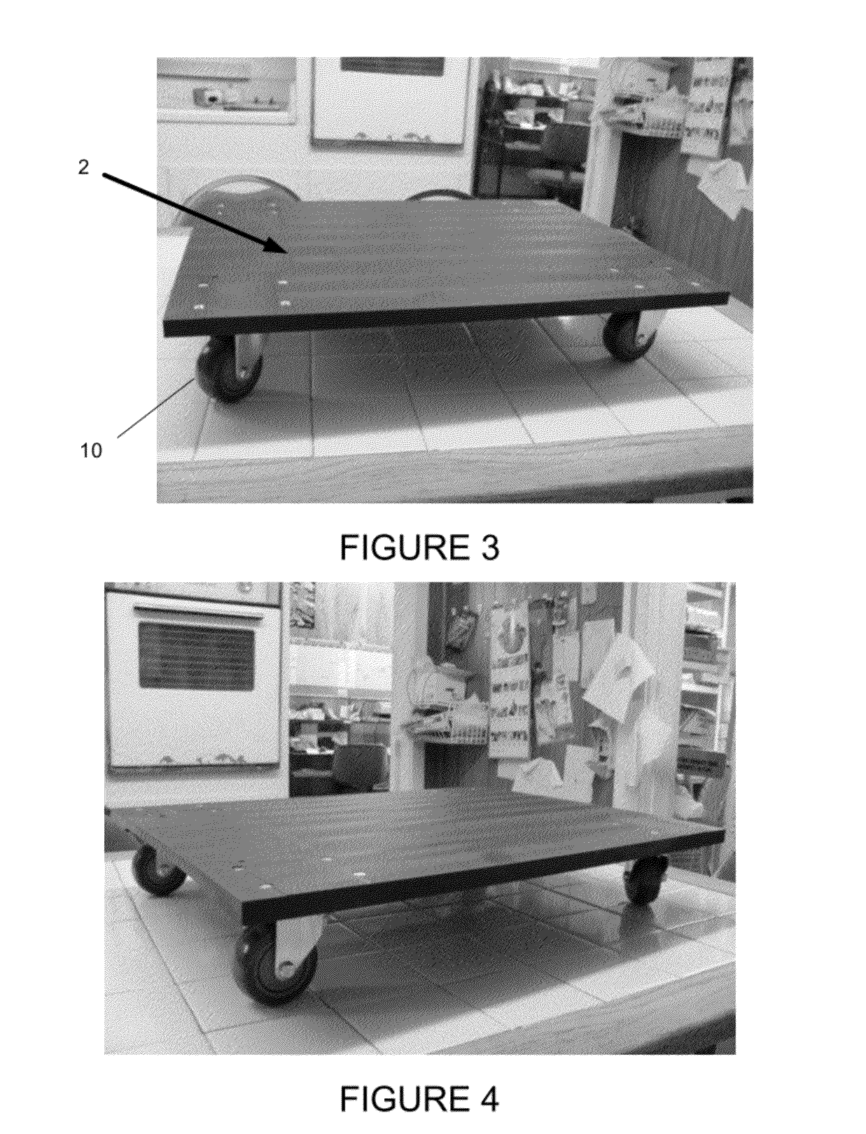

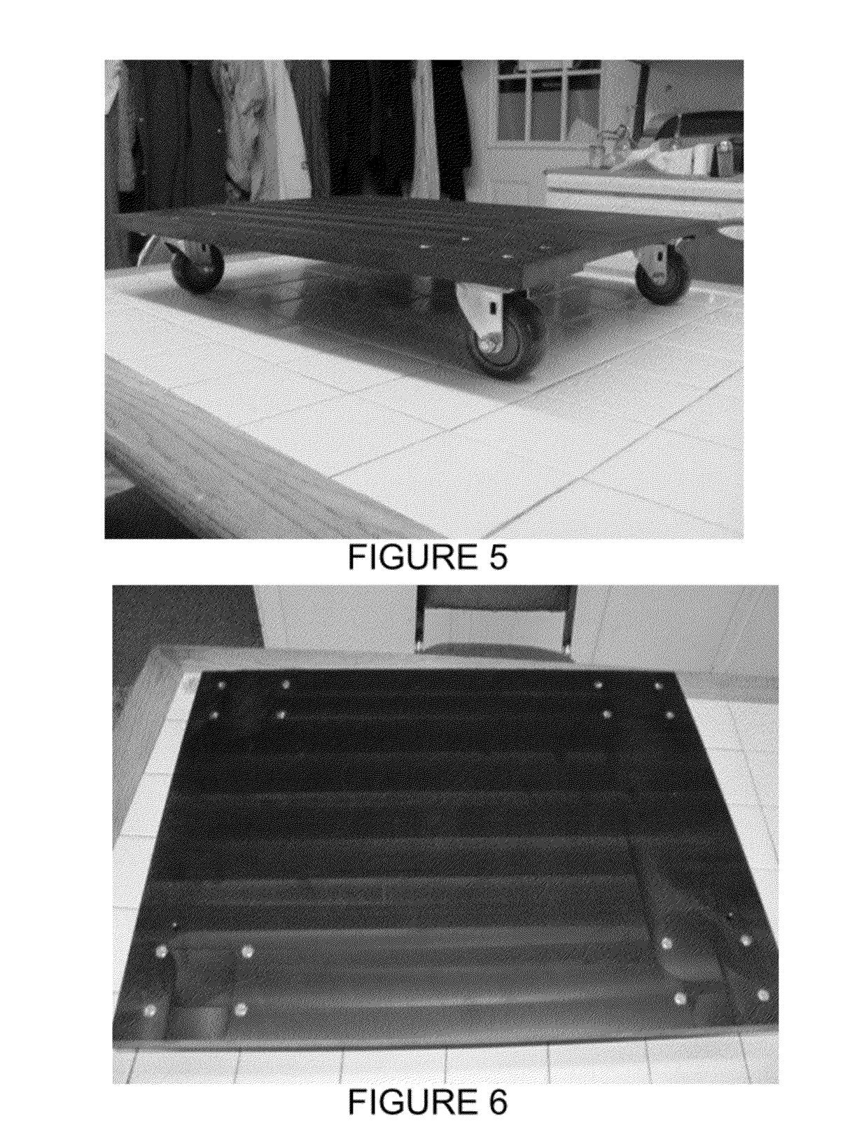

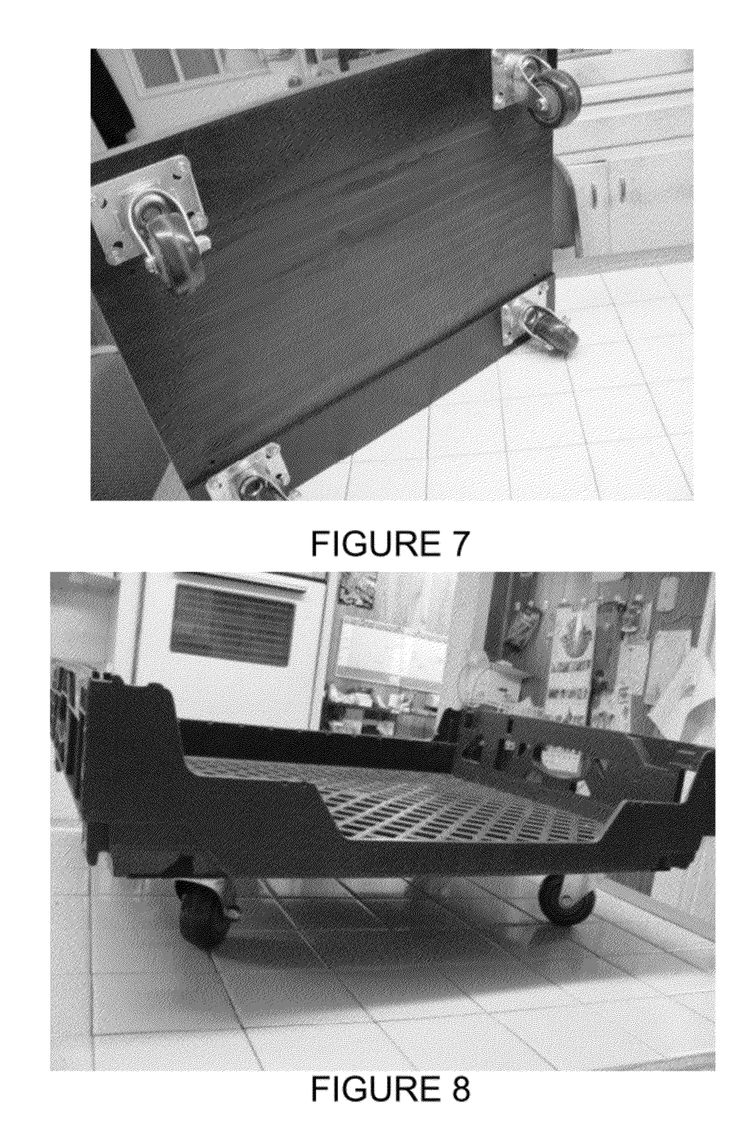

As seen in FIG. 2, the thinner center 6 is obtained by reducing the thickness from the bottom side of the center, so that the top of the dolly appears flat, as seen in FIGS. 3 and 4. However, the thickness also may be reduced from the top side, or from both sides.

In one embodiment, the dolly is made of derlin, although any suitable material such as other plastics, wood, metal, aluminum, steel magnesium, fiberglass, or composite may be used. The dolly may be black, white, or any other color or combination of colors.

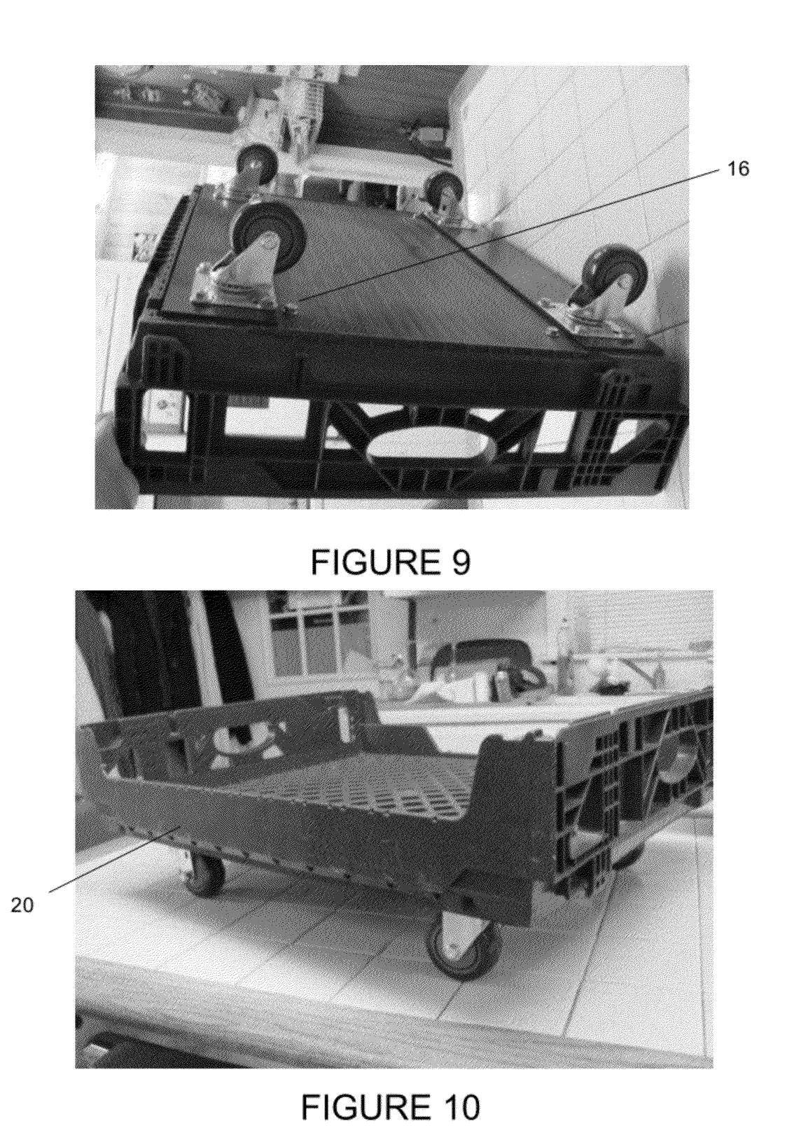

In one embodiment, casters 10, which may be wheels, balls, or the like, are affixed to underside of the dolly in or near the four corners. FIG. 1 shows four holes 12 in each corner to receive a bolt or screw for fastening the casters. Additional holes 14 may be provided to permit the fastening of the dolly to a basket with bolts or screws 16, as seen in FIGS. 9 and 10.

The present invention possesses several advantages over dollies in the prior art. The design of the dolly renders it unable to be seen when in normal use (i.e., “invisible”). In this embodiment, the dolly has no edges, rim, wall or protrusions around its perimeter.

As seen in FIGS. 8 and 9, the dolly fits within the space or pocket on the underside of a basket or tray. In one exemplary embodiment, the dolly is ¾″ inch thick at the sides, and ½″ inch thick in the center. The thick sections or sides 4 extend 4 inches into towards the center, with the dolly being 20 to 21 inches wide and 25 to 26 inches long. However, the dolly can be manufactured in different sizes to accommodate different sizes of baskets or loads.

The basket sits closer to the floor than with conventional dollies, thereby allowing for more product to be hauled within a given space. It is lightweight for easy maneuverability. The casters do not interfere with loading and unloading of a truck. The dolly washes very easily, and has no cavities where dirt can collect or insects can hide and lay eggs. The latter is particularly important in food facilities to prevent food contamination.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A dolly for use with a transport tray or basket with a bottom, comprising:
a rectangular body with four corners, a top side, a bottom side, two long sides and a center section, wherein the long sides are matching in thickness and are thicker than the center section; and
four casters or wheels affixed in the four corners of the rectangular body;
wherein the dolly is fastened to the bottom of the transport tray or basket so the rectangular body cannot be seen when the transport basket is in use.

2. The dolly of claim 1, wherein said casters or wheels are affixed to the thicker long sides of the rectangular body.

3. The dolly of claim 1, wherein the rectangular body has no cavities or similar spaces.

4. The dolly of claim 1, wherein the top side of the rectangular body is flat and smooth.

5. The dolly of claim 1, wherein the rectangular body has no rim or protrusions.

6. A basket and dolly assembly, comprising:
a transport basket or tray with a top and bottom;
a dolly affixed to the bottom of said transport basket or tray, said dolly comprising a rectangular body with four corners, a top side, a bottom side, two long sides and a center section, wherein the long sides are matching in thickness and are thicker than the center section, and four casters or wheels affixed in the four corners of the rectangular body.

7. The assembly of claim 6, wherein the rectangular body of the dolly cannot be seen when the transport basket or tray is in use.

8. The assembly of claim 6, wherein the rectangular body has no cavities or similar spaces.

9. The assembly of claim 6, wherein the top side of the rectangular body is flat and smooth.

10. The assembly of claim 6, wherein the rectangular body has no rim or protrusions.

11. The assembly of claim 6, wherein the rectangular body of the dolly fits within a space on the bottom of the transport basket or tray.
